(19) United States
(12) Patent Application Publication
(10) Pub. No.: US 2012/0272242 A1
(43) Pub. Date: Oct. 25, 2012

(54) PROVISIONING VIRTUAL SERVER

(76) Inventors: Ho-Hyun JEON, Seoul (KR); Dong-Hoon KIM, Gyeonggi-do (KR); Yoon-Bum HUR, Seoul (KR); Jae-Suk AHN, Seoul (KR)

(21) Appl. No.: 13/455,335

(22) Filed: Apr. 25, 2012

(30) Foreign Application Priority Data
Apr. 25, 2011 (KR) 10-2011-0038436

(51) Int. Cl. G06F 9/455

(52) U.S. Cl. 718/1

(57) ABSTRACT

Provided are method and system for provisioning a virtual server. The method may include receiving a request to create a virtual server from a client, determining a client purpose of the requested virtual server, obtaining a previous virtual server usage pattern associated with the client, and creating a virtual server provision based on the client purpose and the previous virtual server pattern.

### CROSS REFERENCE TO PRIOR APPLICATIONS

The present application claims priority under 35 U.S.C. §119 to Korean Patent Application No. 10-2011-0038436 (filed on Apr. 25, 2011), which is hereby incorporated by reference in its entirety.

### FIELD OF THE INVENTION

The present invention relates to a virtual server and, in particular, to provisioning a virtual server according to a previous usage pattern.

### BACKGROUND OF THE INVENTION

A virtual server may be a virtual machine that provides users a computing service similar to that provided by a typical server configured with physical devices and software. Such a virtual server may be provided through server provisioning. Server provisioning may be a set of actions to prepare a virtual server with appropriate systems, data, and software, and make it ready for network operation.

Typically, server provisioning may include tasks of selecting a computing platform such as a processor with memory; loading appropriate software such as an operating system, device drivers, middleware, and applications; customizing and configuring the selected and loaded server elements and parameters thereof.

In general, a virtual server provisioning system may perform server provisioning based on user input for selecting server elements and configuring parameters. For example, the virtual server provisioning system allows users to select server elements, such as server platforms, network storage devices, and software, in order to configure a virtual server. In this manner, users may often select overqualified elements to configure a virtual server. In this case, computing resources may be wasted and users may pay a high cost for using and maintaining the virtual server. Users may also often select less qualified elements to configure the virtual server. In this case, users may be dissatisfied with the virtual server's performance. Such disadvantages in typical server provisioning might degrade overall utilization of a virtual server.

### SUMMARY OF THE INVENTION

This summery is provided to introduce a selection of concepts in a selection of concepts in a simplified from that are further described below in the detailed description with reference to the drawings. This summery is not intended to identify key features or essential features of the claimed subject matter, nor is it intended to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, a virtual server may be provisioned based on a client purpose of a requested virtual server and a previous virtual server usage pattern.

In accordance with an embodiment of the present invention, a method may be provided for provisioning a virtual server. The method may include receiving a request to create a virtual server from a client, determining a client purpose of the requested virtual server, obtaining a previous virtual server usage pattern associated with the client, and creating a virtual server provision based on the client purpose and the previous virtual server pattern.

The determining a client purpose may include prompting the client for information about the client purpose of the requested virtual server, and receiving the client purpose of the requested virtual server in response to the prompt through a user interface.

The determining a client purpose may include providing, as an inquiry, one or more virtual server types to the client through a user interface and allowing the client to select one from the virtual server types as an answer to the inquiry.

The one or more virtual server types may include a personal computer, an office server, a file server, a mail server, and a graphic processing server.

For the obtaining a previous virtual server usage pattern, the method may include retrieving the previous virtual server pattern from a database.

The creating a virtual server provision may include customizing a virtual server configuration according to the client by selecting one or more server elements from a resource pool based on the determined client purpose and the obtained previous virtual server usage pattern, and creating the virtual server based on the customized virtual server configuration.

The one or more server elements may include a server platform, a storage device, a set of applications, and network equipment.

The creating a virtual server provision may include determining whether the customized virtual server configuration matches one of a set of predefined virtual server provisions in a database, recommending to the client as the requested virtual server the one predefined virtual server provision corresponding to the matched customized virtual server configuration if present, otherwise, in the absence of a matched predefined virtual server provision, creating a virtual server provision based on the customized virtual server configuration, and recommending the created virtual server to the client as the requested virtual server.

The recommending may include prompting the client as to whether the recommended virtual server provision is acceptable and if the recommended virtual server provision is acceptable, providing the recommended virtual server provision as the requested virtual server.

The recommending may include otherwise, allowing the client to select server elements from a resource pool if the recommended virtual server provision is unacceptable, creating a virtual server based on server elements selected by the client, and providing the created virtual server as the requested virtual server.

The method may further include providing a virtual server to the client based on the created virtual server provision, collecting information on patterns of using the provided virtual server, and storing the collected information in a database.

In accordance with another embodiment of the present invention, a virtual server provisioning system may be provided for provisioning a virtual server. The virtual server provisioning system may include an input unit, a pattern analysis unit, and a virtual server creation unit. The input unit may be configured to receive a request to create a virtual server from a client. The pattern analysis unit may be configured to determine a client purpose of the requested virtual server, to obtain a previous virtual server usage pattern associated with the client, and to analyze the determined client purpose and the obtained previous virtual server usage pattern. The virtual server creation unit may be configured to create a virtual server provision based on the analysis result.

The pattern analysis unit may be configured to prompt the client for information about the purpose of the requested virtual server through a user interface providing unit and to receive the purpose of the requested virtual server in response to the prompt through a certain user interface provided by a user interface providing unit.

The pattern analysis unit may be configured to provide, as an inquiry, virtual server types to the client through a user interface and to allow the client to select one from the virtual server types as an answer to the inquiry through the user interface provided by a user interface providing unit.

The virtual server types may include a personal computer, an office server, a file server, a mail server, and a graphic processing server.

The previous virtual server pattern may be retrieved from a database.

The virtual server provisioning system may further include a provisioning unit configured to customize a virtual server configuration according to the client by selecting server elements from a resource pool based on the determined client purpose and the obtained previous virtual server usage pattern. The virtual server creation unit may be configured to create the virtual server based on the customized virtual server configuration.

The server elements may include a server platform, a storage device, a set of applications, and network equipment.

The provisioning unit may be configured to determine whether the customized virtual server configuration matches one of a set of predefined virtual server provisions stored in a database, to recommend a predefined virtual server provision to the client as the requested virtual server when the customized virtual server configuration is matched with the predefined virtual server provision, and to create a virtual server provision based on the customized virtual server configuration when the customized virtual server configuration is not matched, and recommend the created virtual server to the client as the requested virtual server.

The provisioning unit may be configured to prompt the client as to whether the recommended virtual server provision is acceptable, to provide the recommended virtual server provision as the requested virtual server if the recommended virtual server is acceptable to the client, otherwise, to allow the client to select server elements from a resource pool if the recommended virtual server is unacceptable to the client, to create a virtual server based on server elements selected by the client, and to provide the created virtual server as the requested virtual server.

The virtual server creation unit may be configured to provide a virtual server to the client based on the created virtual server provision, to collect information on patterns of using the provided virtual server, and to store the collected information in a database.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 shows a virtual server provisioning system in accordance with an embodiment of the present invention;

FIG. 2 shows virtual server provision elements predefined by a virtual server provisioning system in accordance with an embodiment of the present invention;

FIG. 3 shows a virtual server provisioning system in accordance with an embodiment of the present invention; and

FIG. 4A and FIG. 4B show a method for provisioning a virtual server based on client specifications to create a virtual server and previous virtual server usage pattern in accordance with an embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

In accordance with an embodiment of the present invention, a virtual server provisioning system may provision a virtual server based on a client purpose of a requested virtual server and a previous virtual server usage pattern associated with a specific client.

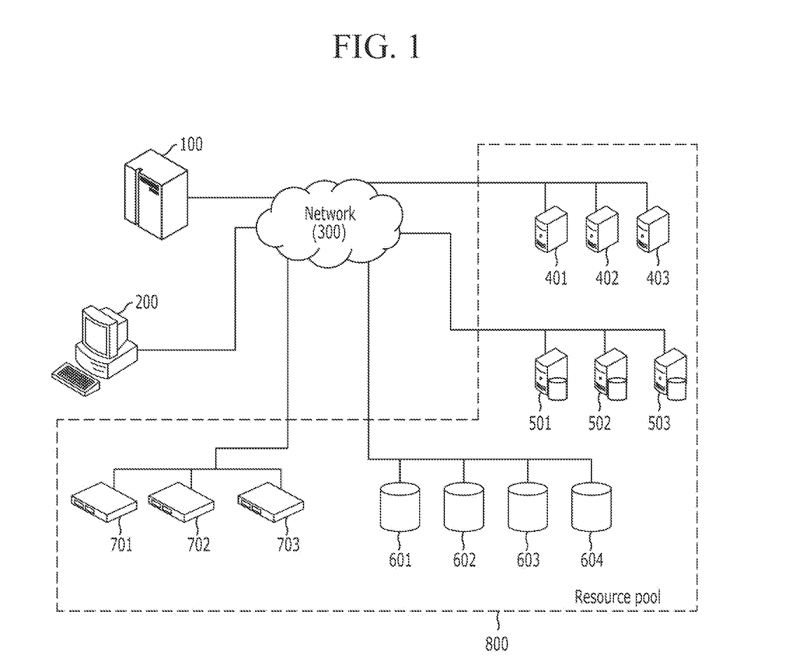

FIG. 1 shows a virtual server provisioning system in accordance with an embodiment of the present invention.

Referring to FIG. 1, virtual server provisioning system 100 may be connected to client device 200 and resource pool 800 through network 300. Virtual server provisioning system 100 may receive a request to create a virtual server from client device 200 and provision a virtual server using physical computing resources included in resource pool 800 based on a client's specifications, system requirements, contractual obligations, provisioning or other purposes (collectively referred to herein as “client purposes”) and a previous virtual server usage pattern associated with a specific client.

Client device 200 may be a computing device capable of communicating with other entities through network 300. For example, client device 200 may be a desktop computer, a laptop computer, a handheld computing device, a smart phone, for example, but the present invention is not limited thereto. Particularly, client device 200 may request virtual server provisioning system 100 to create a virtual server through a user interface provided from virtual server provisioning system 100. In response to the request, client device 200 may be provided, by virtual server provisioning system 100, with virtual computing environments for accessing and using physical computing resources distributed over networks. In order to interact with virtual server provisioning system 100, client device 200 may be provided with a user interface from virtual server provisioning system 100. For example, the user interface may be a web-based interface. The present invention, however, is not limited thereto.

Resource pool 800 may be a group of physical computing resources associated with virtual server provisioning system 100. As shown in FIG. 1, resource pool 800 may include virtual server elements for provisioning virtual servers. Such virtual server elements may be distributed over related networks. For example, resource pool 800 may include server platforms 401, 402, and 403, application servers 501, 502, and 503, network storage devices 601, 602, 603, and 604, and network equipment 701, 702, and 703. Each server element may have a hardware specification different from others. At least one of server elements included in resource pool 800 may be selected and grouped as a virtual server provision by virtual server provisioning system 100.

Virtual server provisioning system 100 may receive a request to create a virtual server from client device 200 and provision a virtual server by selecting necessary server elements from resource pool 800 based on client purposes and a previous virtual server usage pattern associated with a specific client in accordance with an embodiment of the present invention.

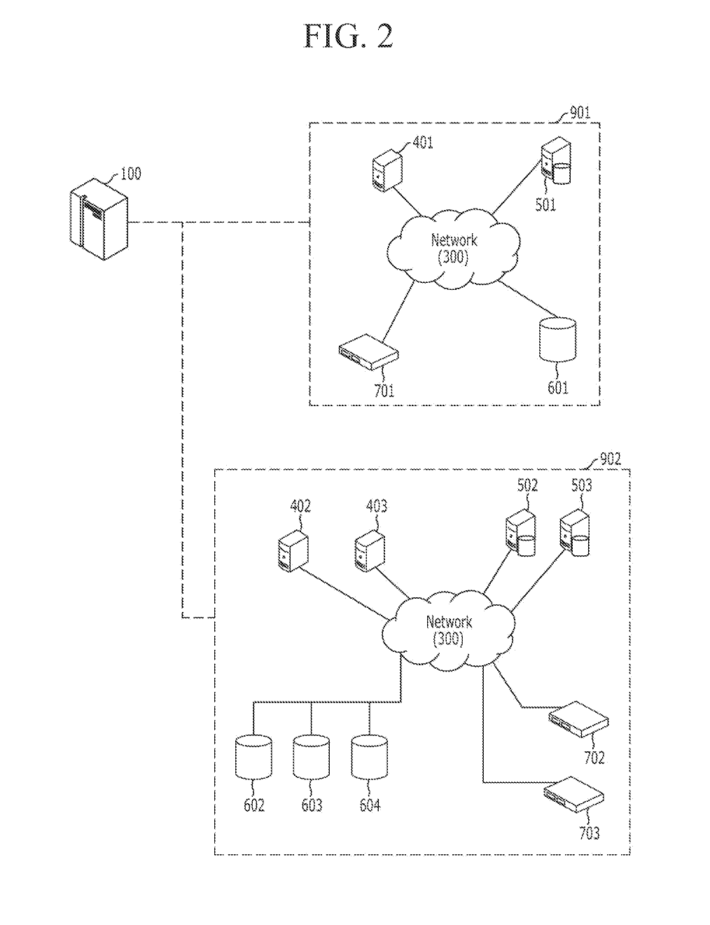

Virtual server provisioning system 100 may predefine a set of virtual server provisions according to general uses of virtual servers. Virtual servers categorized in typical uses may include a personal computer, general servers for a group of 10-50 users, a group of 50-100 users, and a group of 100-500 users, a file server, a mail server, and a graphic processing server, but the present invention is not limited thereto. In order to predefine a set of virtual server provisions, virtual server provisioning system 100 may select necessary server elements from resource pool 800 based on typical specifications required for each virtual server. Such a predefined set of virtual server provisions are illustrated in FIG. 2. Predefining a virtual server provision will be described subsequently with reference to FIG. 2.

Virtual server provisioning system 100 may provide predefined virtual server provisions to a client through a user interface and enable the client to choose one among the provided predefined virtual server provisions. In this manner, the client may more conveniently and quickly create a virtual server. If the client cannot find a desired virtual server among the set of predefined virtual server provisions, virtual server provisioning system 100 enable the client to choose server elements from resource pool 800 and create a virtual server based on the selected server elements.

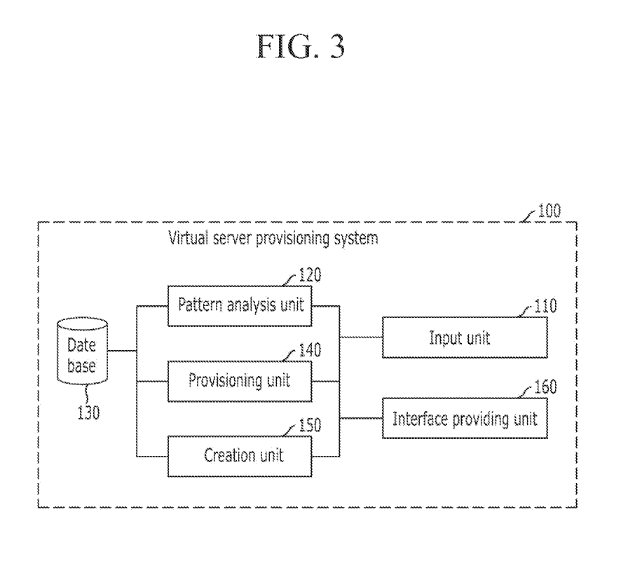

In accordance with an embodiment of the present invention, virtual server provisioning system 100 may determine a client purpose of a requested virtual server and a previous usage pattern associated with the request virtual server. Based on the determination result, virtual server provisioning system 100 may select or modify one from the set of predefined virtual server provisions and provide the selected or the modified virtual server provision. Furthermore, virtual server provisioning system 100 may create a new virtual server provision based on the determination result. Virtual server provisioning system 100 may provide a virtual server based on the selected, modified or created virtual server provision. Such operations of virtual server provisioning system 100 will be described in more detail with reference to FIG. 3.

FIG. 2 shows virtual server provisions defined by a virtual server provisioning system in accordance with an embodiment of the present invention.

Referring to FIG. 2, as described above, virtual server provisioning system 100 may predefine virtual server provisions according to typical uses of virtual servers. For example, virtual server provisioning system 100 may predefine first virtual server provision 901 for a general virtual server for a group of 10-50 users. For first virtual server provision 901, virtual server provisioning system 100 may select server platform 401, application server 501, network storage device 601, and network equipment 701 from resource pool 800 and group the selected server elements as first virtual server provision 901.

Furthermore, virtual server provisioning system 100 may predefine second virtual server provision 902 for a general virtual server for a group of 50-100 users. For second virtual server provision 902, virtual server provisioning system 100 may select two server platforms 402 and 403, two application servers 502 and 503, three network storage devices 602, 603, and 604 and two network equipment 702 and 703, and group the selected server elements as second virtual server provision 902. Virtual server provisioning system 100 may select more server elements for second virtual server provision 902 as compared to first virtual server provision 901, since the general virtual server for a group of 50-100 users may require more processing power, more storage space, more applications for supporting users, and wider network bandwidth. Such configurations for first and second virtual provisions 901 and 902 may be defined based on typical specifications required for each virtual server. After predefining first and second virtual server provisions 901 and 902, virtual server provisioning system 100 may store information on the first and second virtual server provisions 901 and 902.

Such predefined virtual server provisions 901 and 902 may be provided to a client as a selection option to create a virtual server. The client may be allowed to select one of the predefined virtual server provisions 901 and 902 through a user interface provided by virtual server provisioning system 100. In this manner, a client may more conveniently or quickly create a desired virtual server.

If a client desires a virtual server not included in the predefined virtual server provisions 901 and 902, virtual server provisioning system 100 may create a new virtual server provision or modify the existing virtual server provisions 901 and 902 based on the client purpose and the previous virtual server usage patterns associated with a client in accordance with an embodiment of the present invention. Hereinafter, constituent elements of virtual server provisioning system 100 will be described with reference to FIG. 3.

FIG. 3 shows a virtual server provisioning system in accordance with an embodiment of the present invention.

Referring to FIG. 3, virtual server provisioning system 100 may include input unit 110, pattern analysis unit 120, database 130, provisioning unit 140, creation unit 150, and interface providing unit 160.

Input unit 110 may receive various types of input information from client device 200 through a user interface provided by interface providing unit 160. For example, the input information may include input for selecting one of predefined virtual server provisions or input for selecting one or more of server elements included in resource pool 800. Input unit 110 may receive a client purpose of a requested virtual server from a client.

Pattern analysis unit 120 may estimate a virtual server usage pattern for a requested virtual server. Pattern analysis unit 120 may process the client purpose of the requested virtual server, the previous virtual server usage pattern, and statistical analysis results thereof, which are stored in database 130. For example, pattern analysis unit 120 may obtain the client purpose of the requested virtual server, the previous server usage pattern associated with the client, and the statistical analysis results thereof from database 130. Based on the obtained information, pattern analysis unit 120 may determine an optimal virtual server configuration. For example, pattern analysis unit 120 may determine which server elements will be suitable for the requested virtual server based on the client purpose, the previous server usage patterns, and the statistical analysis results thereof.

Provisioning unit 140 may create a virtual server provision customized based on the analysis result of pattern analysis unit 120. For example, based on the analysis result of pattern analysis unit 120, provisioning unit 140 may select virtual server elements from resource pool 180, for example, a server platform, a set of applications including an operating system and software programs, at least one storage device, and network equipment that can provide a required network bandwidth. Then, provisioning unit 140 may provide the customized virtual server provision, as a recommendation, to the client through a user interface.

Furthermore, provisioning unit 140 may provision a set of predefined virtual server provisions. Particularly, provisioning unit 140 may create a set of predefined virtual server provisions for common uses or applications such as, but not limited to, a personal computer, a server for a group of 10-50 users, a server for a group of 50-100 users, and a server for a group of 100-500 users, a file server, a mail server, and a graphic processing server. According to specifications required for a typical server, provision unit 140 may select required physical resources, such as a server platform, a set of applications, a storage device, and network equipment, from the associated resource pool and previously create a set of virtual server provisions with the selected physical resources. Provision unit 140 may provide the set of predefined virtual server provisions, as selection options, to the client through a user interface provided by interface providing unit 160. The client may select one of the provided predefined virtual server provisions. In this manner, the client may quickly and conveniently create a virtual server.

Creation unit 150 may create a virtual server based on the virtual server provisions provided from provision unit 140 and provide the created virtual server to the client. Furthermore, creation unit 150 may create a virtual server based on client selections of server elements. For example, when the client cannot find a desired virtual server from predefined virtual server provisions and/or when the client does not require a virtual server provision customized based on the client purpose and the previous server usage pattern, creation unit 150 may allow a client to select server elements from resource pool 800 and create a virtual server based on the selected server elements. In this case, interface providing unit creation unit 150 may provide a user interface to the client in order to select server elements from resource pool 800.

Database 130 may store information on the client purpose of the requested virtual server, the previous server usage patterns associated with each client, and the statistical analysis result thereof. Such information may be stored in a form of a mapping table. For example, the previous server usage patterns of may be mapped to corresponding clients. The previous server usage patterns may include information on a processing power, a storage size, a set of applications, and a network bandwidth, which were previously employed or otherwise used for virtual servers associated with the client. Database 130 may provide such information to pattern analysis unit 120, provisioning unit 140, and creation unit 150.

Interface providing unit 160 may provide a user interface to the client in order to enable the client to enter various types of inputs. For example, interface providing unit 160 may provide an interface for entering a request to create a virtual server, an interface for entering a purpose of a requested virtual server, an interface for selecting one of the predefined virtual server provisions, and an interface for selecting server elements from resource pool 800. The user interface may be a web-based user interface, but the present invention is not limited thereto.

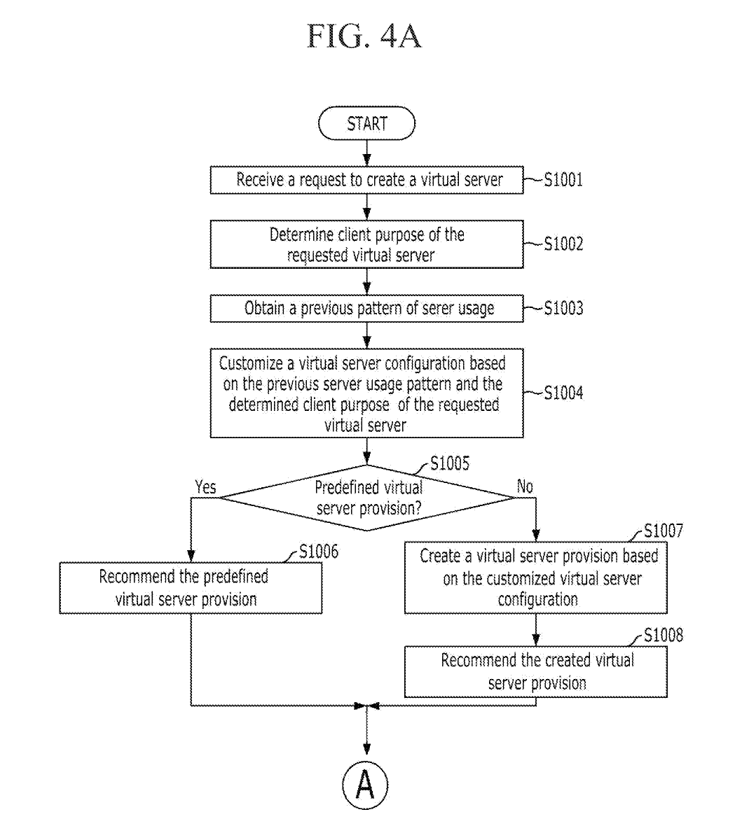

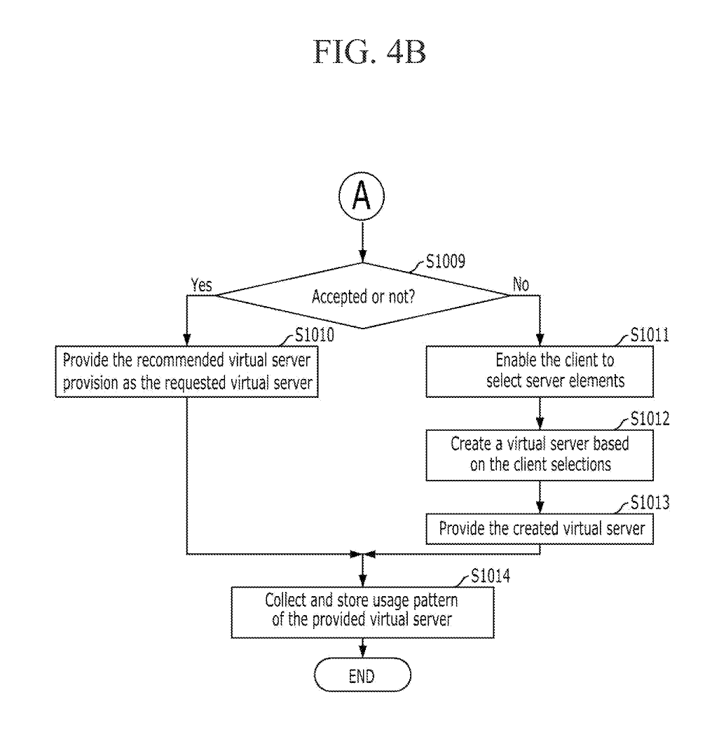

Hereinafter, a method for provisioning a virtual server based on a client purpose to create a virtual server and a previous virtual server usage pattern in accordance with an embodiment of the present invention will be described with reference to FIG. 4A and FIG. 4B.

FIG. 4A and FIG. 4B show a method for provisioning a virtual server based on a client purpose to create virtual server and previous virtual server usage pattern in accordance with an embodiment of the present invention.

Referring to FIG. 4A and FIG. 4B, a request to create a virtual server may be received from a client at step S1001. For example, a client may access virtual server provisioning system 1100 and request virtual server provisioning system 100 to create a virtual server. The client may use a client device to make a request to server provisioning system 100. The client device may be a computing device capable of communicating with other party through a network. For example, the client device may he a desktop computer, a laptop computer, a handheld device, a mobile device, and a smart phone. The client may be provided with a user interface from virtual server provisioning system 100 and enter user inputs through the provided user interface. The user interface may be a web-based user interface. The present invention, however, is not limited thereto.

At step S1002, a client purpose of a requested virtual server may be determined. For example, virtual server provisioning system 100 may inquire of the client about the purpose of the requested virtual server. In response to the inquiry, the client may input the purpose of the virtual server that the user wants to create. Particularly, virtual server provisioning system 100 may provide, as the inquiry, various types of virtual servers classified by purposes thereof and allow the user to choose, as the answer to the inquiry, one of the provided types of virtual servers through the provided web-based interface. For example, the types of virtual servers may be a personal computer, a general server for a group of 10-50 users, a general server for a group of 50-100 users, a general server for a group of 100-500 users, a file server, a mail server, and a graphic processing server. The present invention, however, is not limited thereto. Based on the input of the client, virtual server provisioning system 100 may determine the client purpose of the requested virtual server.

At step S1003, a previous pattern of server usage, associated with the client, may be obtained from a database. For example, such previous patterns of server usage may be stored in database 230. Such information may be stored in a form of a mapping table. For example, previous server usage patterns of may be mapped to corresponding clients. The previous server usage patterns may include a processing power, a storage size, a set of applications, and a network bandwidth, which have, been used for virtual servers associated with the client.

At step S1004, a virtual server configuration may be customized for the client based on the obtained previous server usage pattern and the client purpose of the requested virtual server. For example, virtual server provisioning system 100 may analyze the obtained previous server usage patterns in consideration of the client purpose of the virtual server. Based on the analysis result, virtual server provisioning system 100 may select virtual server elements from associated resource pools, for example, a server platform, a set of applications including an operating system and software programs, at least one storage device, and network equipment that can provide a required network bandwidth. Then, virtual server provisioning system 100 may create a customized virtual server configuration with the selected server elements. Particularly, the customized virtual server configuration may include several elements that may be required for building a virtual server for the client based on the previous server usage pattern and the client purpose of the requested virtual sewer. For example, the client may request to create a general server for a group of 10 to 50 users. The previous server usage pattern of the client shows that the client has used a general server for a group of 10 to 50 users and that the client have frequently added more storage devices. In this case, virtual server provisioning server 100 may customize a virtual server configuration with a server platform and a set of applications for the general server for a group of 10 to 50 users but a storage device and a network bandwidth for a general server for a group of more than 100 users. The present invention, however, is not limited thereto.

At step S1005, determination may be made as to whether the customized virtual server configuration is previously provisioned as a predefined virtual server provision. For example, virtual server provisioning system 100 may search database 230 for a predefined virtual server provision that is matched with the customized virtual server configuration. Virtual server provisioning system 100 may include a set of predefined virtual server provisions that are provisioned for rapidly providing a virtual server to a client. Particularly, virtual server provisioning system 100 may previously provision a set of predefined virtual server provisions fir common uses, such as, a personal computer, general servers for a group of 10-50 users, a group of 50-100 users, and a group of 100-500 users, a file server, a mail server, and a graphic processing server. According to a common specification required for a general server, virtual server provisioning system 100 may select required physical resources, such as a server platform, a set of applications, a storage device, and network equipment, from the associated resource pool and previously create a set of virtual server provisions. Such information may be stored in database 130 as predetermined virtual server configurations.

At step S1006, the searched predefined virtual server provision, which is matched with the customized virtual server configuration, may be recommended to the client when there is a predefined virtual server provision matched with the customized virtual server configuration (Yes—S1005). For example, virtual server provisioning system 100 may provide the searched predefined virtual server provision, as a recommendation for the virtual server, to the client through a web-based interface and enable the client to accept such recommendation.

At step S1007, a virtual server provision may be created based on the customized virtual server configuration when a predefined virtual server provision matched with the customized virtual server configuration is absent (No—S1005). For example, virtual server provisioning system 100 may create a virtual server provision based on the customized virtual server configuration when a predefined virtual server provision matched with the customized virtual server configuration is absent. Virtual server provisioning system 100 may create a virtual server provision based on the customized virtual server configuration.

At step S1008, the created virtual server provision may be recommended to the client. For example, virtual server provisioning system 100 may provide the created virtual server provision, as a recommendation for the virtual server, to the client through a web-based interface and enable the client to accept such recommendation.

At step S1009, determination may be made as to whether the recommended virtual server provision is accepted by the client. For example, the virtual server provision may be provided to the client through a user interface. The user interface of virtual server provisioning system 100 may allow the client to choose whether the recommended virtual server is accepted or not. For example, the user interface may be a web-based user interface.

At step S1010, the recommended virtual server provision may be provided to the client as the requested virtual server when the client accepts the recommended virtual server provision (Yes—S1009). For example, when the client accepts the recommended virtual server provision is accepted, virtual server provisioning system 100 may provide the virtual server provision to the client as the requested virtual server.

At step S1011, the client may be allowed to select each server element from the resource pool if the client declines the recommended virtual server provision (No—S1009). For example, virtual server provisioning system 100 may provide a user interface to enable the client to choose server elements from the resource pool. Based on the user interface, the client may select server elements, such as a server platform, a storage device, a set of applications, and network equipment, from the resource pool associated with virtual server provisioning system 100.

At step S1012, a virtual server may be created based on the user selections of server elements. For example, virtual server provision system 100 may create a virtual server based on the user selections of server elements,

At step S1013, the requested virtual server is provided to the client. For example, virtual server provision system 100 may provision, program, or otherwise initiate the virtual server and provide necessary computing environment elements for enabling the client's use of the initiated virtual server.

At step S1014, usage patterns of the provided virtual server may be collected and stored in database 230. For example, virtual server provision system 100 may collect information on usage patterns of the provided virtual server, such as a processing load rate, a storage availability rate, usage of each application, and a bandwidth occupancy rate. Such collected information may be stored in database 230 and used for determining a virtual server provision customized to a client.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein o mean serving as an example, instance, or illustration, aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or dear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for provisioning a virtual server, the method comprising:
receiving a request to create a virtual server from a client;
determining a client purpose of the requested virtual server;
obtaining a previous virtual server usage pattern associated with the client; and
creating a virtual server provision based on the client purpose and the previous virtual server pattern.

2. The method of claim 1, wherein the determining a client purpose includes:
prompting the client for information about the client purpose of the requested virtual server; and
receiving the client purpose of the requested virtual server in response to the prompt through a user interface.

3. The method of claim 1, wherein the determining a client purpose includes:
providing, as an inquiry, one or more virtual server types to the client through a user interface; and
allowing the client to select one from the virtual server types as an answer to the inquiry.

4. The method of claim 3, wherein the one or more virtual server types include a personal computer, an office server, a file server, a mail server, and a graphic processing server.

5. The method of claim 1, wherein, for the obtaining a previous virtual server usage pattern, retrieving the previous virtual server pattern from a database.

6. The method of claim 1, wherein the creating a virtual server provision includes
customizing a virtual server configuration according to the client by selecting one or more server elements from a resource pool based on the determined client purpose and the obtained previous virtual server usage pattern; and
creating the virtual server based on the customized virtual server configuration.

7. The method of claim 6, wherein the one or more server elements include a server platform, a storage device, a set of applications, and network equipment.

8. The method of claim 6, wherein the creating a virtual server provision includes:
determining whether the customized virtual server configuration matches one of a set of predefined virtual server provisions in a database;
recommending to the client as the requested virtual server the one predefined virtual server provision corresponding to the matched customized virtual server configuration if present;
otherwise, in the absence of a matched predefined virtual server provision, creating a virtual server provision based on the customized virtual server configuration, and recommending the created virtual server to the client as the requested virtual server.

9. The method of claim 8, wherein the recommending includes:
prompting the client as to whether the recommended virtual server provision is acceptable; and
if the recommended virtual server provision is acceptable, providing the recommended virtual server provision as the requested virtual server.

10. The method of claim 9, wherein the recommending includes:
otherwise, allowing the client to select server elements from a resource pool if the recommended virtual server provision is unacceptable;
creating a virtual server based on server elements selected by the client; and
providing the created virtual server as the requested virtual server.

11. The method of claim 1, further comprising:
providing a virtual server to the client based on the created virtual server provision;
collecting information on patterns of using the provided virtual server; and
storing the collected information in a database.

11. A virtual server provisioning system for provisioning a virtual server, the virtual server provisioning system comprising:
an input unit configured to receive a request to create a virtual server from a client;
a pattern analysis unit configured to determine a client purpose of the requested virtual server, to obtain a previous virtual server usage pattern associated with the client, and to analyze the determined client purpose and the obtained previous virtual server usage pattern; and
a virtual server creation unit configured to create a virtual server provision based on the analysis result.

12. The virtual server provisioning system of claim 11, wherein the pattern analysis unit is configured to:
prompt the client for information about the purpose of the requested virtual server through a user interface providing unit; and
receive the purpose of the requested virtual server in response to the prompt through a certain user interface provided by a user interface providing unit.

13. The virtual server provisioning system of claim 11, wherein the pattern analysis unit is configured to:
provide, as an inquiry, virtual server types to the client through a user interface; and
allow the client to select one from the virtual server types as an answer to the inquiry through the user interface provided by a user interface providing unit.

14. The virtual server provisioning system of claim 13, wherein the virtual server types include a personal computer, an office server, a file server, a mail server, and a graphic processing server.

15. The virtual server provisioning system of claim 11, wherein the previous virtual server pattern is retrieved from a database.

16. The virtual server provisioning system of claim 11, further comprising a provisioning unit configured to customize a virtual server configuration according to the client by selecting server elements from a resource pool based on the determined client purpose and the obtained previous virtual server usage pattern,
wherein the virtual server creation unit is configured to create the virtual server based on the customized virtual server configuration.

17. The virtual server provisioning system of claim 16, wherein the server elements include a server platform, a storage device, a set of applications, and network equipment.

18. The virtual server provisioning system of claim 16, wherein the provisioning unit is configured to:
determine whether the customized virtual server configuration matches one of a set of predefined virtual server provisions stored in a database;
recommend a predefined virtual server provision to the client as the requested virtual server when the customized virtual server configuration is matched with the predefined virtual server provision; and
create a virtual server provision based on the customized virtual server configuration when the customized virtual server configuration is not matched, and recommend the created virtual server to the client as the requested virtual server.

19. The virtual server provisioning system of claim 18, wherein the provisioning unit is configured to:
prompt the client as to whether the recommended virtual server provision is acceptable;
provide the recommended virtual server provision as the requested virtual server if the recommended virtual server is acceptable to the client;
otherwise, allow the client to select server elements from a resource pool if the recommended virtual server is unacceptable to the client;
create a virtual server based on server elements selected by the client; and
provide the created virtual server as the requested virtual server.

20. The virtual server provisioning system of claim 11, wherein the virtual server creation unit is configured to:
provide a virtual server to the client based on the created virtual server provision;
collect information on patterns of using the provided virtual server; and
store the collected information in a database.
